(19) United States
(12) Patent Application Publication
(10) Pub. No.: US 2003/0003348 A1
(43) Pub. Date: Jan. 2, 2003

(54) Fuel cell

(76) Inventor: Gregory M. Hanket, Newark, DE (US)

Correspondence Address: Arnold S Weintraub, Plunkett & Cooney, Suite 3000, 38505 Woodward Avenue, Bloomfield Hills, MI, 48304, US

(21) Appl. No.: 10/181,593

(22) PCT Filed: Jan. 16, 2001
(86) PCT No.: PCT/US01/01408

(51) Int. Cl. H01M 4/96; H01M 4/88; H01M 4/90; B05D 5/12

(52) U.S. Cl. 429/44; 429/42; 502/101; 427/115

(57) ABSTRACT

A liquid electrolyte fuel cell is defined by a pair of spaced apart electrodes having an insulative layer therebetween, each electrode having an electrocatalyst deposited thereon. Each of the electrodes and the insulative layer is at least partially nanoporous, i.e., having a pore size of from about 0.5 to about 50 nm. The electrodes are fabricated by pyrolizing a suspension of conductive carbon dispersed in a pyrolyzable precursor solution, preferably, a mixture of a non-graphitizing carbon, e.g., polyfufuryl alcohol and a pore size regulator, e.g. polyethylene glycol. Viscosity of the precursor solution is controlled with acetone, or other carbonyl-containing compound. The electrodes are bonded to the insulative layer either by further pyrolysis of an intermediate precursor solution or with an adhesive gel. The electrodes and insulative layer or matrices are impregnated with a suitable electrolyte to form the cell.

### CROSS-REFERENCE TO RELATED APPLICATIONS

This application is a completion application of co-pending U.S. Provisional Patent application, Serial No. 60/176,468, for “Fuel Cell” filed Jan. 17, 2000, the disclosure of which is hereby incorporated by reference.

### FIELD OF THE INVENTION

The present invention pertains to fuel cells. More particularly, the present invention pertains to electrolytic fuel cells. Even more particularly, the present invention concerns a unitary anode/electrolyte/cathode assembly for electrolytic fuel cells.

### DESCRIPTION OF THE PRIOR ART

As is known to those skilled in the art, generally, an electrolytic fuel cell is used for directly converting chemical energy to electrical energy. Such a fuel cell comprises a pair of spaced apart electrodes with an electrolyte system disposed therebetween which electrically insulates the electrodes from one another and facilitates ionic conduction between the electrodes. Usually, there is a positive electrode, denoted as the cathode, and a negative electrode, denoted as the anode. In use fuel and oxidant streams are flowed over the exterior of the electrodes.

Present day fuel cells are characterized by their electrolyte. The most common types of fuel cells are molten carbonate (MCFC); solid oxide (SOFC), liquid electrolyte fuel cells such as phosphoric acid (PAFC), and alkaline (AFC), as well as proton exchange membrane (PEMFC) fuel cells. Fuel cells with low operating temperatures (T<250° C.) are PAFCs or AFCs using immobilized liquid electrolytes, or PEMFCs using a mechanically stable, electrolytic polymer film, such as Nafion® (DuPont). The fuel cell electrodes are typically fabricated from an electrically conductive, carbon-based material. The carbon source is typically powdered carbon black or powdered graphite. The electrode is formed by either sintering the powder to form a rigid, porous structure (PAFCs and AFCs), or by pressing the powdered carbon into the surface of a PEM film. In manufacturing a fuel cell electrode, usually an electrocatalyst is required to facilitate the electrochemical reaction.

A key requirement for the manufacture of fuel cells is the containment of the electrolyte between the electrodes. In the case of PEMFCs, this is achieved by chemically binding acidic sulfonate groups to the polymer backbone. Electrolyte immobilization in PAFCs and AFCs is achieved by using a porous “matrix” which retains the electrolyte via a “sponge” or “capillary” effect.

Fuel cells, as described above, suffer from certain deficiencies. In the case of PEMFCs, sufficient proton conductivity of the electrolyte membrane is only achieved when water is absorbed into the membrane. The requirement for water absorption limits the operating temperature of such fuel cells—if the operating temperature is too high, water evaporates out of the membrane and the proton conductivity is critically reduced. This limited operating temperature makes these fuel cells susceptible to poisoning of the electrocatalyst by contaminants, an example being carbon monoxide.

One of the drawbacks associated with present cells using liquid electrolyte (PAFCs and AFCs) is the tendency for the electrolyte to “seep” out of the electrolyte matrix into the porous electrodes, thereby flooding the electrocatalyst and preventing mass transfer of fuel and oxidant species to the electrocatalyst surface. This is typically prevented by incorporating hydrophobic particles, such as polyethylene tetraflouride particles, such as those sold under the name Teflon®, into the electrode structure. Liquid electrolyte fuel cells suffer from a further drawback. In order to achieve mechanical stability, the sintered electrodes and electrolyte matrix, e.g. sintered silicon carbide, must necessarily be relatively thick compared to PEMFCs. This thickness contributes to an increased bulk over PEMFCs and also a greater separation between anode and cathode. The increased distance between anode and cathode results in increased electrolytic losses during operation. PAFCs and AFCs do have a significant advantage over PEMFCs in that water retention is not a requirement for sufficient proton conductivity. PAFCs can be operated at higher temperatures than PEMFCs, thereby increasing the tolerance of the electrocatalyst to contaminants. One drawback of the high operating temperatures, at least in the case of PAFCs, is the gradual loss of electrolyte by evaporation over time.

Also, and, as is known to those skilled in the art to which the present invention pertains, the electrolyte or electrolyte system used today is an electrolyte gel. These electrolyte gels are well known. They may be aqueous or non-aqueous and may be solid or liquid or a combination of thereof. The gel, per se, is polymer based. Generally, the art describes polymer gel electrolytes as two phase systems where the first phase is an electrolyte active species and the second phase is substantially inert and does not absorb the electrolyte active species and is present to support the active species and reduce swelling of the gel electrolyte. The polymers used in these gels include polyvinyl fluoride, polyurethane, polyethylene oxide, polyacrylonitrile, polymethylmethacrylate, polyacrylamide, polyvinyl acetate, and the like as a first phase and a polymeric second phase of polyalkylene such as polyethylene, polypropylene; aromatic polymers such as polystyrene; hexamethyleneadipamide (Nylon), etc. Representative of the gels which are well known are those found in U.S. Pat. Nos. 5,658,685; 5,766,787 and 4,031,037, the disclosures of which are hereby incorporated by reference.

### SUMMARY OF THE INVENTION

As discussed hereinafter, the present invention, in a first aspect, seeks to alleviate the problems outlined above by providing an adsorbent membrane for retaining a liquid electrolyte. The adsorbent film has a nanoporous, rigid microstructure. This is distinct from PEMFC membranes which can also be considered nanoporous, but which swell upon absorption of a liquid phase. A further distinction between the present invention and PEMFC electrolyte membranes is that the electrolytically active species is not necessarily chemically bound to the nanoporous matrix.

The nanoporous matrix enables a reduction in the vapor pressure of the liquid electrolyte within the pores of the matrix. This enables liquid electrolyte to be held within the pores of the matrix at vapor pressures below the dew point, thereby rendering electrolyte migration out of the matrix more thermodynamically unfavorable than in present liquid electrolyte fuel cells.

Furthermore, in a second aspect hereof, there is disclosed a method for manufacturing the above described fuel cell assembly as a unitary member.

For a more complete understanding of the present invention, reference is made to the following detailed description and accompanying drawing. In the drawing like reference characters refer to like parts throughout the several views in which:

### BRIEF DESCRIPTION OF THE DRAWINGS

FIG. 1 is a side view of an electrode in accordance herewith;

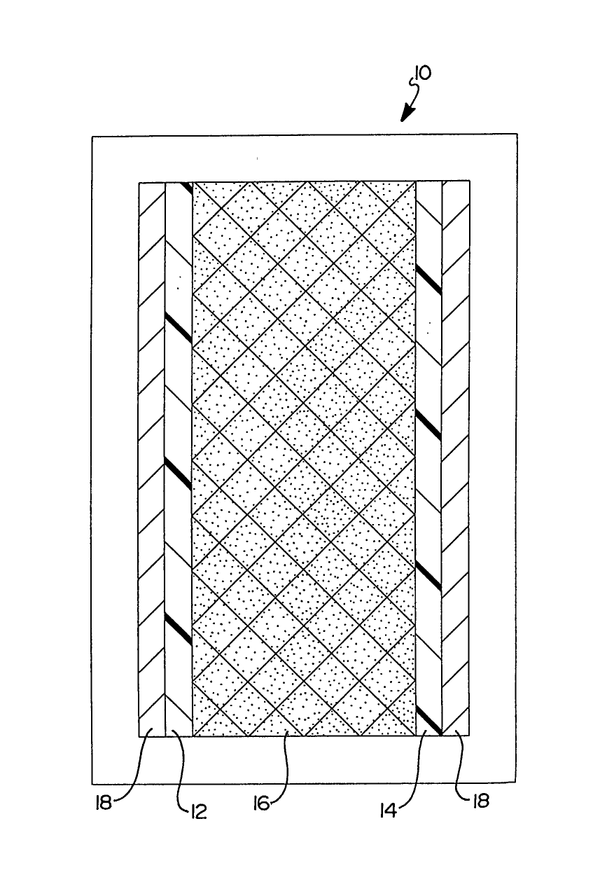

### DESCRIPTION OF THE PREFERRED EMBODIMENT

With more particularity, and reference to the drawing, there is provided an electrolytic fuel cell, generally, denoted at 10. The fuel cell 10 hereof, generally, comprises a cathode 12, an anode 14 and an insulator or insulator matrix 16 disposed therebetween.

An electrocatalyst layer is deposited on both the cathode and the anode, as at 18 and 20, respectively. Any well known electrocatalyst may be used herein and as described below.

According to the present invention, it is necessary that the anode, the cathode, and the matrix all be at least partially comprised of a nanoporous material in order to provide a continuous electrolyte path between the anode and the cathode. Both the anode and cathode are electrically conductive with the insulator being non-conductive. As noted, each of the anode, cathode, and insulator are formed, at least in part, from a nanoporous material. By the term nanoporous it is meant a pore size from about 0.5 to 50 nm. The functional significance of the nanoporous pores is to provide a sufficient ratio of pore surface area to pore volume so that the vapor pressure of a liquid phase held within the pores is reduced.

The nanoporous matrix is used, preferably, to manufacture a unitary fuel cell assembly. Thus, according hereto, each of the insulator matrix, cathode and anode are fabricated at least partially from the nanoporous material, and if required, a conductive agent, such as graphite powder, to increase the electrical conductivity of anode and cathode, each of the anode, cathode and insulator can be completely nanoporous. If necessary, the mechanical stability of the unitary assembly may be enhanced by the addition of the appropriate materials, such as carbon fiber or carbon paper.

The assembly hereof is fabricated by: (a) forming the electrodes, individually, each electrode being formed from a suspension of conductive carbon in a first pyrolysis precursor solution, (b) pyrolyzing each of the solutions, (c) bonding the electrodes together with a second liquid pyrolysis precursor solution and (d) pyrolyzing the second solution.

Among the suitable pyrolysis precursor solutions for use herein is a solution of (a) polyfurfuryl alcohol (PFA), (b) polyethylene glycol (PEG), and, optionally, (c) acetone. PFA is considered a “non-graphitizing” carbon source, and will therefore produce an electrically insulating pyrolysis product. The PEG is used to modify the pore size distribution of the pyrolyzed PFA matrix. Preferably, the polyethylene glycol has a molecular weight ranging from about 600 amu to about 8,000 amu and results in a pore size of between 30 and 200 Angstrom (Å). The influence of PEG in the formation of pores in pyrolyzed PFA is described by Lafyatis et al. in Industrial Engineering Chemical Research, 1991, the disclosure of which is hereby incorporated into by reference. The weight fraction of the glycol to the alcohol is sufficient to result in a high void fraction within the pyrolyzed carbon. The weight fraction of acetone in the precursor solution is sufficient to result in a viscosity suitable for brushing, spraying, etc., as desired.

The electrodes used herein are preferably fabricated from pyrolized carbon. Pyrolized carbon electrodes are known. See, inter alia, U.S. Pat. Nos. 5,851,504; 5,636,437, and 4,031,292, the disclosures of which are hereby incorporated by reference. Preferably, the electrodes are formed by first impregnating a carbon fiber paper with a suspension of conductive carbon in a solution of a pyrolysis precursor. The consistency of the suspension may range from a low-viscosity liquid to a high-viscosity paste, depending on the amount of viscosity control agent used. The conductive carbon may be any or all of the following: 10-100 micron carbon fiber, 10-500 micron graphite flake, 1-10 micron graphite powder, and <1 micron carbon black. A suitable composition for a pyrolysis precursor/conductive carbon suspension generally comprises from about 8 to 12 wt %<170 mesh graphite flake, 7 to 12 wt % ˜1 micron graphite powder, 1.0 to 3.0 wt %<1 micron carbon black, from about 30 to 35 wt % polyfurfuryl alcohol, and 40 to 50 wt % acetone. Impregnation of the carbon paper with a pyrolysis precursor/conductive carbon suspension is performed on a substrate such as titanium or nickel-iron foil to which the electrode will not adhere after pyrolysis. A liftoff agent, such as poly(ethylene glycol), may be applied to the foil substrate to ease the removal of the pyrolyzed electrode from the foil substrate.

The impregnated paper is then pyrolyzed at a sufficient temperature, typically 600° C. or greater, to polymerize the alcohol and form a nanoporous microstructure of the pyrolysis precursor. By using different physical forms of the carbon, there is provided a pyrolyzed carbon composite electrode which is then removed from the substrate. Alternatively, the electrode may be formed by repeated application of similar or dissimilar suspensions, pyrolysis precursors, or conductive carbon mixtures to the substrate, incorporating multiple intermediate pyrolyses followed by one single pyrolysis.

Regardless of the fabrication method, the resulting electrodes are typically between 10 and 1000 micrometers in thickness. If desired, the use of carbon paper may be omitted by applying the suspension directly to the foil substrate.

In creating a fuel cell, two of the manufactured electrodes are bonded together using the second paralysis precursor which may be similar or different from the first pyrolysis precursor solution used to form the individual electrodes; the second pyrolysis precursor solution may contain, if necessary, particulated, suspended, electrically-insulating pyrolyzed carbon to further prevent physical contact between the two electrodes. In bonding the electrodes together, a layer of solution is interposed the electrodes and they are pressed together, with a coating or layer of insulating second precursor solution therebetween. Upon pyrolysis of this assembly, the pyrolysis precursor and particulated, electrically-insulating pyrolyzed carbon form a rigid, nanoporous, electrically insulating layer which binds the two electrodes together. The insulating layer or matrix is typically less than 100 micrometers in thickness, and furthermore serves to seal any cracks or pinholes that may be present in the electrodes.

Clearly, materials other than pyrolyzed carbon may be used to provide an insulating layer between the two electrodes. By interposing a gel adhesive between the two opposed electrodes there is provided an anode-insulator-cathode assembly. Where this technique is employed the reactants which are prerequisite to form the polymer gel are sprayed on opposing insulating faces of the electrodes and the two non-conductive surfaces of the electrodes are then pressed together such that cross-linking occurs forming the polymer gel which binds the two electrodes together. Alternatively, the gel may be deposited on each electrode individually and, thereafter, the two assemblies are then compressed and adhered. After the electrode—insulator—electrode assembly is prepared, an electrocatalytic layer is deposited onto the outer electrode surfaces by spraying, brushing or the like, an electrocatalyst-containing sol or suspension thereunto. Such electrocatalytic sols and suspensions are well known and are typically metal based and in particular, composed, preferably suspended platinum black, which is an electrocatalyst ink. The use of electrocatalyst inks in fuel cells has already been described by Chun et al. in NASA Tech Brief Vol. 23, No. 4. Alternately, a chloroplatinic acid in acetone solution may be brushed or sprayed onto the electrode surfaces and then subjected to a reduction reaction.

By this technique, there is then provided a one-piece fuel cell membrane which is ready for incorporation into a fuel cell.

Alternately, the electrode-insulator-electrode structure may be fabricated by first forming the insulating layer, which functions as a membrane. The fabrication of the insulating layer or matrix is the same as the electrode fabrication previously described, with the exception that particulated, electrically-insulating pyrolyzed carbon is used in place of conductive carbon. Carbon fiber or carbon paper may still be used to provide mechanical stability so long as care is taken to minimize the electrical conductivity of the so-produced membrane. This membrane may then be used as both the electrolyte matrix as well as the substrate for creating the electrodes. To fabricate the electrodes thereafter there is deposited on a first surface or side of the so-produced membrane an electrocatalyst. First, though, a mixture of conductive carbon and precursor solution as described above is applied to either face of the membrane prior to depositing the catalyst. This can be achieved by either applying a suspension consisting of conductive carbon and pyrolysis precursor, or by applying a pyrolysis precursor solution to the membrane and then dusting on the carbon powder. Alternately, any number of applications of the precursor solution, dry mixture of conductive carbon, or suspension of conductive carbon in the precursor solution, using any number of intermediate pyrolyses, may be performed. The structure is then given a final pyrolysis. Thereafter, the procedure is repeated on the opposite side of the film. Thus, as a result thereof the film now has two electrically conductive faces with no electrical conduction therebetween. It is understood that potentially external support of the membrane may be necessary. If so, an electrically conductive carbon fabric, paper, or felt may or may not be adhered directly to the electrocatalyst surface.

Alternately, the assembly may be fabricated by using the pyrolysis precursor, and if desired the particulated pyrolyzed carbon, to bond already known gas diffusion electrodes made from sintered carbon powders.

The assembly is then impregnated with an electrolyte species, such as an orthophosphoric acid (H₃PO₄)/water solution.

In any event, though, it is to be appreciated that by the present invention there is provided one-piece liquid electrolyte fuel cells which are immediately ready for installation in a fuel cell.

In installing the present assemblies, a vapor pressure less than the saturation pressure of the electrolyte species is held above the anode and/or cathode to maintain pore saturation of the nanoporous matrix without condensation of a bulk electrolyte phase. A preferred electrolyte to matrix volume ratio is a least 1:10 or greater with a preferred pore size of between about 5 Å to about 60 Å. The present structure provides certain advantages over fuel cells which are presently known. For example, by depositing the electrocatalyst onto the surface of a nanoporous electrode it is possible to maintain a continuous electrolyte path between anode and cathode electrocatalytic surfaces without risk of flooding. Furthermore, in a typical PEMFC which uses carbon particles with platinum active sites, when the particles are pressed into the polymer electrolyte film, a significant percentage of the platinum active sites are pressed into the polymer and become functionally inaccessible to the fuel and oxidant. By depositing the electrocatalyst on a continuous rigid surface all the catalyst remains accessible to the fuel and oxidant. Furthermore, the present invention provides a certain degree of self-regulation in the event that flooding begins to occur. Because of flooding, electrochemical efficiency drops creating a rise in the temperature of the cell. This rise in temperature increases the heat content resulting in evaporation of the flooding electrolyte, especially where the electrolyte contains a significant fraction of water. The present structure will not exhibit a volume change as water and the active electrolyte species are adsorbed, thus increasing cell life.

Also, it is to be appreciated that the pore size can be regulated to maximize the operating temperature of the cell. As the pore size decreases, the cell can operate at a higher temperature while still maintaining pore saturation. Furthermore, having and maintaining the preferred volume ratio of electrolyte to matrix, the nanoporous matrix with adsorbed electrolyte theoretically offers greater proton conductivity than typical PEM electrolytes. By being able to operate at a higher temperature, stack cooling schemes are simplified as well as decreasing sensitivity to carbon monoxide poisoning of the electrocatalyst surfaces.

Among the useful electrocatalytic materials, platinum is most often employed. However, the electrocatalyst need not be limited to a platinum-based layer. Any noble metal catalyst may be used herein, including, for example, platinum, rubidium, rhodium, palladium, silver, nickel, molybdenum, osmium, iridium, and gold, as well as mixtures thereof These metal catalysts may be deposited not only by solution deposition but by vacuum deposition or vapor deposition, as well. A comprehensive discussion of the formation of electrocatalytic layers is disclosed in the aforementioned U.S. Pat. No. 4,031,292.

In addition, the electrolyte need not be limited to a phosphoric acid/water electrolyte. Rather, other liquid electrolyte solutions may be used herein as the impregnate for the film or adsorbent material. Thus, the impregnate may be any acid, either mineral or weak organic such as, for example, sulfuric acid, hydrochloric acid, nitric acid, acetic acid, fumaric acid, etc., and the like as well as mixtures thereof Similarly, the impregnate need not be acid-based but may be a basic solution such as an aqueous solution of caustic soda (sodium hydroxide), lithium hydroxide, potassium hydroxide as well as any other alkaline hydroxide. It should be further noted with respect hereto that any nanoporous material can be used as the matrix or film membrane so long as it is an absorbent material which will enable it to be impregnated with the electrolyte. After impregnation of the matrix by the electrolyte, the electrolyte species may or may not chemically bond to the matrix.

As noted hereinabove the present invention contemplates the regulation of the pore size of the matrix. In controlling the pore size the polyfurfuryl alcohol provides a pore size of 1 to 15 Angstrom upon pyrolysis. It is known that the polyethylene glycol when added to the alcohol-acetone solution gives a large pore size to the pyrolysis product, the pore size increasing with increasing polyethylene glycol molecular weight. Thus by regulating the amount of polyethylene glycol and the molecular weight thereof it is possible to regulate both the number of pores and the pore size, respectively. It is contemplated that the mechanical stability of the membrane may also be controlled by the pore size distribution. For example, the mechanical stability of the membrane may be improved by first fabricating a membrane which has pores which are both too large and too numerous for proper adsorptive properties. However, this film may exhibit improved mechanical properties due to its ability to tolerate increased internal and external mechanical stresses without fracturing. A second application of different precursor solution could then be applied to “fill in” the large pores and suitably modify the adsorptive properties of the membrane.

As a fuel cell, ultimately, the fuel breaks down into carbon dioxide and hydrogen atoms or protons which migrate through the matrix to the cathode where it forms water with oxygen which is introduced into the cell on the cathode side thereof.

Any gas or liquid or any other combustible product is used to generate the reaction with the electrolyte to cause the migration. Thus, hydrogen, methanol, ethanol or the like may be used on the anode side of the cell. The fuel cell must necessarily include exhaust ports to drain off any gas therefrom.

It should, also, be noted that polyfurfuryl alcohol is not the only pyrolysis precursor which may be used. Other precursors which will also result in the formation of a nanoporous pyrolyzed carbon matrix include, for example, polyacrylonitrile, polyvinyl chloride, and polyvinylidene chloride as taught by Foley, Microporous Materials, 1995. Furthermore, any substantially inert fiber may be used to enhance the mechanical stability of the membrane.

In use and as is known to those skilled in the art to which the present invention pertains, suitable electrode contactors or flow field plates may be employed which serve to both deliver fuel or oxidant to the anode or cathode, respectively, and remove exhaust streams, and also to conduct the electrical current generated at each of the anode and cathode to a suitable receptor which then utilizes the electricity so created. See, for example, U.S. Pat. No. 5,432,023, the disclosure of which is incorporated hereby. If necessary, an electrically conductive, gas permeable, mechanically compressible material such as carbon felt, paper, or the like may be interposed between the membrane and flow field plate to prevent mechanical damage to the membrane.

Also, since the electrocatalyst surfaces are directly exposed to the gas phase the fuel cell may also offer potential advantages as a hydrolyzer by reversing the operation of the fuel cell.

It is to be appreciated from the preceding that there has been described herein improved unitary assemblies for use in electrolyte fuel cells.

Having, thus, discussed the invention, what is claimed is:

1. A liquid electrolyte fuel cell, comprising:
(a) a first pyrolyzed carbon electrode, having an inner and outer surface,
(b) an electrolyte impregnable insulative layer, and
(c) a second pyrolyzed carbon electrode, having an inner and outer surface,
(d) a electrocatalyst deposited on the outer surface of each electrode, one of the electrodes defining an anode, the other electrode defining a cathode, the insulative layer being interposed the electrodes, each of the electrodes and the insulative matrix layer comprising at least a partially nanoporous material to provide a continuous electrolyte path between the anode and the cathode.

2. The fuel cell of claim 1 wherein:
each of the electrodes comprises a pyrolyzed fully nanoporous electrically conductive carbon.

3. The fuel cell of claim 2 wherein:
the insulative layer is a matrix comprising a pyrolyzed non-graphitizing carbon source.

4. The fuel cell of claim 1 wherein:
the insulative layer is a matrix comprising a pyrolyzed fully nanoporous, non-graphitizing carbon source.

5. The fuel cell of claim 4 wherein:
the insulative layer comprises a pyrolyzed admixture of polyfurfuryl alcohol and polyethylene glycol.

6. The fuel cell of claim 1 wherein:
the electrocatalyst is a noble metal.

7. The fuel cell of claim 1 wherein:
the insulative layer is an electrolyte gel.

8. The fuel cell of claim 1 which further comprises:
a liquid electrolyte impregnant.

9. A method of manufacturing a liquid fuel cell which comprise:
(a) suspending a first conductive carbon in a first pyrolysis precursor solution;
(b) pyrolyzing the suspension to form at least a partial nanopourous first electrode;
(c) suspending a second conductive carbon in a second pyrolysis precursor solution;
(d) pyrolyzing the second solution to form at least a partial nanoporous second electrode;
(e) bonding the first and second electrodes together, with an interposed insulative nanoporous material; each electrode having an exposed outer surface;
(f) depositing an electrocatalyst on the exposed surface of each electrode to form a fuel cell; and
(g) impregnating the fuel cell with a liquid electrolyte.

10. The method of claim 9, which further comprises:
interposing a third pyrolysis precursor solution between the electrode and, thereafter,
pyrolyzing the electrodes and the third solution,
the pyrolysis causing the bonding of the electrodes together.

11. The method of claim 9 wherein:
the first and second conductive carbons each comprises a carbon fiber paper, and
wherein the suspension is deposited on a non-adhering substrate prior to pyrolyzing the suspension.

12. The method of claim 9 wherein:
the insulative nanoporous material is an adhesive gel.

13. The method of claim 9 wherein the insulative nanoporous material is a pyrolizable non-graphitizing carbon material, and further wherein:
the pyrolizable non-graphitizing material bonds the electrode together, and defines the insulative at least partial nanoporous material, the method further comprising:
immersing each of the electrodes in a third pyrolizable precursor solution,
pyrolizing the third solution and electrodes to bond the electrode to the insulative nanoporous material.

14. The method of claim 9 wherein:
the insulative layer is an insulative adhesive gel.

15. The method of claim 15 wherein each of the first, second and third pyrolizable precursor solutions consists essentially of an admixture of polyfurfuryl alcohol, polyethylene glycol and a viscosity controlling amount of acetone.

16. The method of claim 9 wherein the conductive carbon is a mixture of different physical forms of conductive carbon.

17. The liquid electrolyte fuel cell of claim 5 wherein:
the conductive carbon is a mixture of different physical forms of conductive carbon.
